(19) United States
(12) Patent Application Publication
(10) Pub. No.: US 2009/0214399 A1
(43) Pub. Date: Aug. 27, 2009

(54) VACUUM PROCESSING APPARATUS

(76) Inventors: Minoru Yatomi, Kudamatsu-shi (JP); Akitaka Makino, Hikari-shi (JP); Shingo Kimura, Shunan-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/041,029

(22) Filed: Mar. 3, 2008

(30) Foreign Application Priority Data
Feb. 22, 2008 (JP) 2008-041668

(51) Int. Cl. B01J 19/08

(52) U.S. Cl. 422/186.04

(57) ABSTRACT

The invention provides a vacuum processing apparatus for processing a sample placed within a processing chamber in a vacuum reactor using plasma generated within the processing chamber, the apparatus comprising an atmospheric transfer chamber disposed on a front portion of the apparatus for transferring the sample under atmospheric pressure, a vacuum transfer chamber arranged on a rear side of the atmospheric transfer chamber for transferring the sample in the inner side of the chamber being vacuumed, a lock chamber disposed between and connecting the vacuum transfer chamber and the atmospheric transfer chamber, a plurality of vacuum processing units including vacuum reactors and arranged in the circumference of and connected to the vacuum transfer chamber, and a plurality of flow controllers arranged in a space below the vacuum transfer chamber or the lock chamber for controlling flow rates of a plurality of gases for processing the sample to be supplied respectively to the vacuum processing units.

The present application is based on and claims priority of Japanese patent application No. 2008-041668 filed on Feb. 22, 2008, the entire contents of which are hereby incorporated by reference.

### BACKGROUND OF THE INVENTION

1. Field of the Invention

The present invention relates to vacuum processing apparatuses for processing substrate-shaped samples such as semiconductor wafers placed within a processing chamber arranged in a vacuum reactor having its inner side vacuumed, and more specifically, relates to vacuum processing apparatuses having a vacuum transfer reactor with a plurality of vacuum reactors connected to the circumference thereof and having its inner side vacuumed for transferring samples into and out of processing chambers.

2. Description of the Related Art

In above-described types of vacuum processing apparatuses, especially semiconductor vacuum processing apparatuses for processing substrate-shaped samples such as semiconductor wafers in a vacuumed processing chamber using plasma generated in the processing chamber, there are demands for improving the efficiency of processing the samples as the object being processed, along with the miniaturization and refinement of the processes. Recently, in response to such demands, there have been developed a so-called multichamber apparatus in which a plurality of vacuum reactors are connected to form a plurality of processing chambers in a single apparatus. In such apparatuses having a plurality of processing chambers for performing processes, each processing chamber is connected to a vacuum transfer reactor including a transfer chamber capable of having its inner pressure controlled to vacuum pressure and including a transfer device such as a robot arm disposed therein for transferring samples in the inner side thereof.

By adopting the above-described arrangement, it becomes possible to increase the number of samples to be processed per unit time in a single vacuum processing apparatus, and thus, it becomes possible to improve the productivity per footprint within the site of the user, such as a clean room having a plurality of such vacuum processing apparatuses installed therein. Normally, these types of vacuum processing apparatuses are arranged in a row along and on a width-direction end of a linear path in which cases containing samples such as cassettes are transferred via robots within the clean room. As the number of apparatuses arranged along a single path increases, the number of samples being processed per unit time in a single plant is increased, and thus, the efficiency is improved.

Therefore, according to such vacuum processing apparatuses installed within a building of a plant, it is required that the size of the space occupied by the apparatus in its installed state is minimized, and it is especially required that the width of the apparatus in the direction of the transfer path and the area of the floor of the building occupied by the apparatus in the state in which the apparatus is installed is minimized. Further, since it is necessary to perform periodic maintenance of such apparatuses, it is necessary that the space for performing maintenance is ensured. Normally, a predetermined width on the floor on which the apparatus is installed is provided as allowance space in which no objects are arranged on and above the floor surrounding the body of the apparatus, so as to allow users and maintenance operators to pass therethrough with maintenance supplies and tools. Examples of such prior art vacuum processing apparatuses are disclosed in Japanese patent application laid-open publication No. 2005-101598 (prior art 1) and Published Japanese translations of PCT international publication No. 2001-509646 (prior art 2).

Prior art 1 discloses a vacuum processing apparatus having processing units including vacuum reactors arranged in the circumference of a transfer reactor and being connected in a removable manner to each side of the transfer reactor having a polygonal planar shape, wherein each processing unit includes an upper portion having a vacuum reactor and electric field and magnetic field generating means for generating plasma, and a lower portion having a bed for storing utilities such as power supplies and control units required for processing samples in the vacuum reactor. Further, prior art 2 discloses a similar vacuum processing apparatus having a plurality of processing modules arranged on the circumference of the vacuum transfer reactor and connected thereto in a removable manner, wherein the gas, water, power and the like supplied to processing chambers which are vacuum reactors constituting the processing modules are supplied via pipes and cables passing a distributor disposed in an area below a side portion of the vacuum transfer reactor and further passing the space immediately below the vacuum transfer reactor to be connected to the processing modules.

However, such prior art apparatuses had the following drawbacks.

That is, according to the prior art, the various gases used for processing in processing units or processing modules are either supplied directly to each processing module via a distributor (prior art 2), or via a connecting unit of gases supplied from a floor below disposed on a rear side of the atmospheric transfer reactor and through a space below the vacuum transfer reactor to mass flow controllers (MFC) of gases disposed between the processing units, in which the gas supply is controlled before being fed to the respective processing units (prior art 1). However, according to such arrangements, even if the pipes and cables are attached in a removable manner so as to enable the processing units or modules to be attached and removed, if the variety of gases being supplied is increased, the load of the operation for removing these pipes and cables for maintenance and inspection or the alignment operation after attachment becomes significant, by which the nonoperating time of the apparatus is extended and the efficiency of the process is deteriorated. Such drawbacks of the prior art have not been considered sufficiently.

For example, in recent semiconductor wafer etching processes, in order to improve the processing efficiency, it is required that the multilayered films or a single material film deposited on the upper surface of the semiconductor wafer is processed continuously under various conditions by changing the varieties and flow rates of gases to be supplied for processing without transferring the wafer out of the processing chamber. In order to realize such processes, the vacuum processing apparatus must be capable of supplying a greater variety of gases in various flow rates, and therefore, the number of gas pipes and lines for supplying gases to the processing modules or processing units is increased. Therefore, the distributor and the mass flow controllers for gases have grown in size to correspond to the increased number of pipes and lines to be connected thereto, by which the amount of work related to connecting and disconnecting the pipes and lines therewith when attaching or removing processing modules or units to and from the main body of the apparatus or the vacuum transfer reactor has been increased significantly, and therefore, the nonoperating time of the apparatus is increased and the processing efficiency is deteriorated.

Moreover, the large-sized distributor and MFCs require greater occupation area and volume when being stored in the apparatus, and they were protruded from the prior art arrangement, increasing the footprint and width of the installed vacuum processing apparatus. For example, according to patent document 1, the MFC is arranged in the processing unit such as the interior of the bed of the respective processing unit, or the MFC is arranged in the control unit placed between an etching unit and an ashing unit. However, when the MFC is arranged in the bed, the above-mentioned drawbacks are caused when removing or attaching the processing unit including the bed.

Further, even by providing a control unit, the control unit must be removed when detaching a processing unit or attaching a new processing unit in the limited space between vacuum processing apparatuses arranged adjacent to one another along a cassette transfer path, by which the work related to attaching and removing the pipes may become significant. Further, according to the arrangement in which the MFC is stored in the bed, the increased capacity of the MFC leads to the increase in volume and footprint of the bed, by which the maintenance space and operation space is undesirably reduced.

On the other hand, it is considered possible to arrange the plurality of MFC units and the distributor in a location distant from the processing modules or units, and to connect a small number of pipes and lines for supplying a gas mixture containing a variety of gases to the processing units and modules. However, if the distance between the MFCs and the processing chambers is extended, the response in the change of conditions such as change of processing gases for performing continuous processing is deteriorated, by which the throughput is reduced and the processing efficiency is deteriorated.

### SUMMARY OF THE INVENTION

The object of the present invention is to provide a vacuum processing apparatus capable of cutting down the work related to maintenance and inspection operations and improving the efficiency of the processes. Another object of the present invention is to provide a vacuum processing apparatus capable of reducing the footprint and improving the efficiency of the processes. Yet another object of the present invention is to provide a vacuum processing apparatus capable of improving throughput and enhancing the efficiency of the processes.

The objects of the present invention are achieved by a vacuum processing apparatus for processing a sample placed within a processing chamber in a vacuum reactor using plasma generated within the processing chamber, the apparatus comprising: an atmospheric transfer chamber disposed on a front portion of the apparatus for transferring the sample under atmospheric pressure; a vacuum transfer chamber arranged on a rear side of the atmospheric transfer chamber for transferring the sample in the inner side of the chamber being vacuumed; a lock chamber disposed between and connecting the vacuum transfer chamber and the atmospheric transfer chamber; a plurality of vacuum processing units including vacuum reactors and arranged in the circumference of and connected to the vacuum transfer chamber; and a plurality of flow controllers arranged in a space below the vacuum transfer chamber or the lock chamber for controlling flow rates of a plurality of gases to be supplied respectively to the vacuum processing units for processing the sample.

The object is further achieved by a vacuum processing apparatus in which the vacuum transfer chamber is disposed in a reactor having a polygonal planar shape and having vacuum processing units attached in a removable manner to side walls constituting the polygonal sides of the reactor.

The object is further achieved by a vacuum processing apparatus further comprising a gas distributor disposed between the atmospheric transfer chamber and the vacuum processing unit arranged on the rear side of the atmospheric transfer chamber, and connected to a plurality of pipes for gases supplied from below a floor surface on which the vacuum processing apparatus is installed for distributing the plurality of gases to the plurality of flow controllers, respectively.

The object is further achieved by a vacuum processing apparatus in which the center portions of the processing chambers within the plurality of vacuum processing units are arranged circumferentially around a vertical center axis of the vacuum transfer chamber, and the plurality of flow controllers are arranged below the vacuum transfer chamber circumferentially around the vertical axis and in an order corresponding to the circumferential position of the corresponding vacuum processing units.

Moreover, the object is achieved by a vacuum processing apparatus in which upper surfaces of the plurality of flow controllers are composed of planes of the same height, and a space in which a worker can perform operation is provided between the vacuum transfer chamber and the plurality of flow controllers.

### BRIEF DESCRIPTION OF THE DRAWINGS

FIG. 1 is an upper view showing the overall structure of the vacuum processing apparatus according to a preferred embodiment of the present invention;

FIG. 2 is a side view showing the outline of the structure of the vacuum processing apparatus according to the embodiment shown in FIG. 1;

FIG. 3 is a plan view showing the arrangement of MFC units and processing units disposed below a transfer chamber according to the embodiment of FIG. 1;

FIGS. 4A and 4B are views showing the arrangement of the MFC units of FIG. 3 in further detail; and

FIGS. 5A, 5B and 5C are three side views showing the structure of the gas distributor of FIG. 4.

### DETAILED DESCRIPTION OF THE PREFERRED EMBODIMENTS

The preferred embodiments of the present invention will now be described with reference to the drawings.

### Embodiment 1

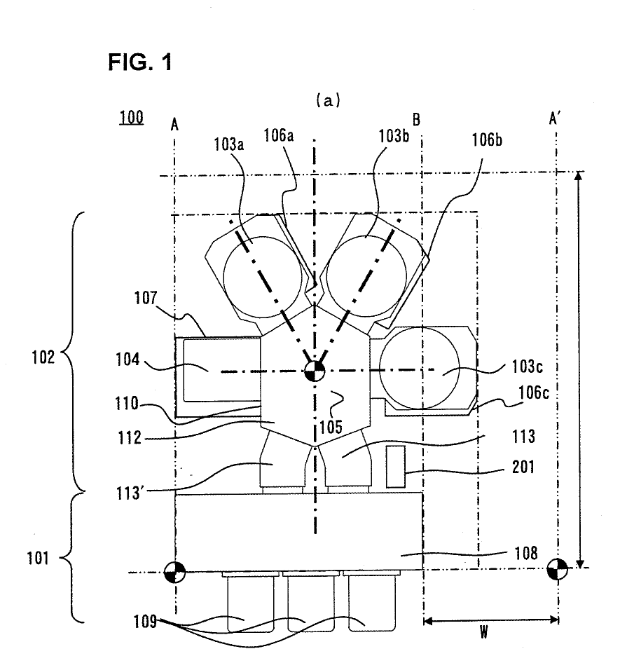

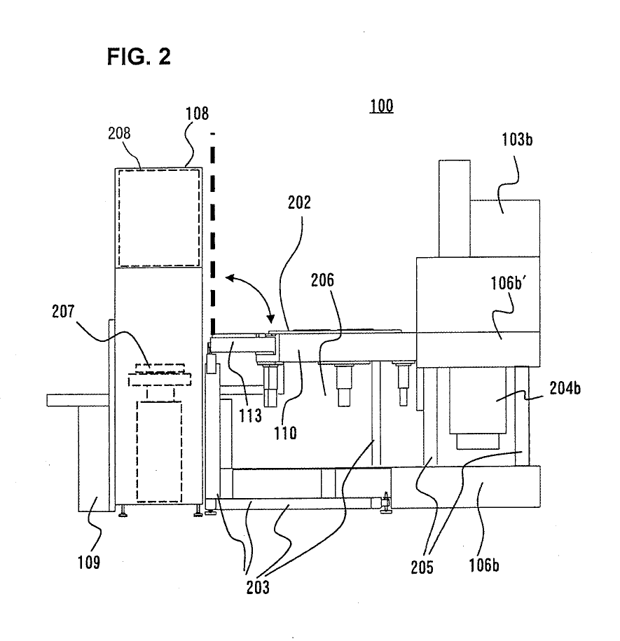

FIG. 1 is a plan view showing the outline of the whole structure of a vacuum processing apparatus according to the present invention, which is taken from above. FIG. 2 is a side view showing the vacuum processing apparatus according to the embodiment of FIG. 1 from the side. In the present embodiment, an atmospheric block 101 disposed on a front side of the vacuum processing chamber 100, which is the lower side in the drawing of FIG. 1, is the area in which wafers are carried, stored, positioned and handled under atmospheric pressure, and a vacuum block 102 disposed on the rear side or upper side in the drawing is a processing block in which the wafers are carried and processed under a pressure vacuumed from atmospheric pressure and where pressure is increased and decreased while wafers are placed therein.

As described in detail later, according to the present embodiment, a housing 108 arranged in the atmospheric block 101 on the front side of the vacuum processing chamber 100 is arranged at a position biased toward the left side in the horizontal direction when seen from the front side of the vacuum processing apparatus 100, which is on the same side as the processing unit 104. In the vacuum block 102, a plurality of processing units 103a, 103b, 103c and 104 are disposed around a transfer unit 105 equipped with a vacuum transfer chamber 110 having a substantially polygonal planar shape in which the planar shape thereof is either polygonal or composed of combinations of curved sides and planar sides so that the defined shape is assumed as a polygonal shape. The processing units 103a, 103b, 103c and 104 are connected to each side of the polygonal shape of the vacuum transfer chamber 110, and the processing chambers disposed in each of the processing units in which plasma is formed are communicated with the interior of the chamber of the transfer unit 105. On the other hand, the transfer unit 105 is connected to a rear side portion of the atmospheric block 101 at an end on the lower side of the drawing, so that the atmospheric side in which the wafers are transferred and the vacuum side in which the processes are performed are communicated so as to allow the wafers to be handed over from one side to the other.

The atmospheric block 101 includes a housing 108 having placed therein an atmospheric transfer chamber for transferring the wafers under atmospheric pressure, and a plurality of (three according to the present embodiment) cassette tables 109 placed on the front side or lower side in the drawing of the vacuum processing chamber 100 for mounting cassettes on the front side facing a passage for transferring cassettes housing wafers therein. The housing 108 has an atmospheric transfer chamber formed therein, which defines a space in which a robot for transferring wafers is capable of moving along the row of cassette tables 109 (which is along the passage), and the space has a horizontal width equal to or greater than the width of the three cassette tables 109. Further, an alignment device not shown for aligning the center position of wafers is arranged at the upper left end area of the drawing.

As described in detail later, the processing units 103a, 103b, 103c and 104 are respectively equipped with an upper portion including the vacuum reactor and a bed portion arranged underneath for housing components such as a power supply and a control unit used for processes performed in the processing chamber of the vacuum reactor, wherein beds 106a, 106b, 106c and 107 constituting the respective bed portions are also arranged around the vacuum transfer chamber 110.

As described, in the space between the rear side of the atmospheric block 101 and the vacuum transfer reactor 110 which is a vacuum reactor having arranged therein a vacuumed transfer chamber 112 and constituting a transfer unit 105 are arranged lock chambers 113 and 113′ for connecting the atmospheric block and the vacuum transfer reactor and handing over wafers. In the lock chamber 113 or 113′, when a wafer is transferred via a robot arm (not shown) disposed in the interior of the transfer chamber 112 within the vacuum transfer reactor 110 having the interior thereof vacuumed to be placed therein, the pressure of the interior of the lock chamber is raised to atmospheric pressure, and then the wafer is placed on a different robot arm (not shown) disposed in the space within the housing 108 constituting the atmospheric block 101 and taken out toward the atmospheric block 101. The wafer having been taken out in this manner is either returned to the original position within the cassette table 109 or returned to other cassettes. Further, a wafer taken out from one of the cassette tables 109 via the robot arm is placed in one of the lock chambers 113 or 113′ set to atmospheric pressure, and then the interior of the lock chamber is vacuumed, and the wafer is placed on the robot arm in the transfer chamber 112 having its interior vacuumed in the same manner, to bed passed through the transfer chamber 112 and carried into one of the processing units 103a, 103b, 103c or 104.

In order to perform the above operation, a gas vacuum unit and a gas supply unit are connected to the lock chambers 113 and 113′ for communicating the atmospheric block 101 and the transfer chamber of the transfer unit and increasing or decreasing the pressure therein with the transferred wafer placed therein. Therefore, gate valves (not shown) for opening or closing the lock chambers 113 and 113′ and sealing the interior of the chambers in an airtight manner are disposed on the front and rear portions of the chambers. Further, each lock chamber has disposed therein a stage on which the wafer is placed and a means for fixing the wafer to the stage when the inner pressure is increased or decreased. In other words, the lock chambers 113 and 113′ are equipped with a means for sealing the chambers withstanding the pressure difference created between the interior and exterior thereof with the wafer placed therein.

The transfer unit 105 is composed of a transfer chamber 112 having its inner side vacuumed and including a robot arm (not shown) for transferring wafers between the lock chamber 113 and the respective processing units 103a, 103b, 103c and 104, and the above-described lock chambers 113 and 113′. Further according to the present embodiment, a robot arm (not shown) for transferring wafers is placed in the interior of the transfer chamber 112, so as to hand over wafers between the four processing units arranged in the circumference of the transfer chamber 112 and the atmospheric block 101.

According further to the present embodiment, the processing units 103a, 103b, 103c and 104 are composed of three etching units and one ashing unit, wherein the respective vacuum reactors are connected in a removable manner to the respective sides of the transfer chamber 112 of the transfer unit 105. The vacuum vessel 110 inside of which the transfer chamber 112 is disposed has a pentagonal or hexagonal planar shape, and the sides constituting the left and right edges thereof when seen from the front side of the vacuum processing chamber 100, which is the lower side of the drawing, are symmetric and parallel to one another at equal distances from a front-rear axis of the vacuum processing apparatus 100 extending in the vertical direction in the drawing and passing the center of the transfer chamber 112, and perpendicular to the floor. Further, the two sides constituting the rear sides in the upper area of the drawing are perpendicular sides arranged symmetrically at given angles with respect to the front-rear axis.

The etching units 103a through 103c are connected in a removable manner to the symmetric sides corresponding to the two rear sides of the transfer chamber 112 and one side corresponding to the right end side when seen from the upper direction, the ashing unit 104 is connected to a left end side of the transfer chamber 112, and the lock chambers 113 and 113′ are connected to the remaining sides of the transfer chamber 112. In another words, according to the present embodiment, three etching chambers and one ashing chamber are disposed radially around a center of the transfer chamber 112 having a polygonal planar shape being detachably connected to side walls corresponding to sides of hexagon respectively.

According further to the present embodiment, the processing units 103 and 104 connected to the transfer unit 105 are attached in a removable manner to the transfer unit 105, and in the transfer unit 105, the lock chambers 113 and 113′ and the transfer chamber 112 are also attached in a removable manner. Further, the processing units 103a, 103b and 103c attached to the main body of the vacuum processing apparatus 100 are of the same shape or have components attached thereto in the same arrangement with respect to the center of the transfer chamber 112. The processing units 103a through 103c are each composed of a vacuum reactor and a sample stage on which the wafer is placed within a processing chamber in the interior of the vacuum reactor. The processing units 103a through 103c are arranged so that they are at equal distances with respect to an axis passing the vertical direction (perpendicular to the floor) at the center of rotation of the robot (crossing point of the broken lines in the drawing) disposed within the transfer chamber 112 and driven by a driving apparatus not shown disposed underneath to rotate, extend and contract so as to transfer the wafers. The ashing unit 104 also comprises a vacuum reactor, a processing chamber and a sample stage, arranged in the same manner.

According to the present embodiment, the vacuum block 102 including the processing units 103a, 103b, 103c and 104 and the transfer unit 105 is largely divided into an upper portion and a lower portion. The vacuum block is divided into a chamber portion having the interior thereof vacuumed in which semiconductor wafers as the sample to be processed are handled, and a bed portion disposed underneath the chamber portion and supporting the same, including beds 106 arranged on the floor of the room in which the vacuum processing apparatus 100 is installed and housing therein equipments required for the chamber portion.

The bed 106 of each processing unit 103a, 103b, 103c and 104 in the bed portion has a substantially rectangular box shape, and stores in the interior thereof utilities and control units required in the chamber portion disposed above the bed. A bed frame including the bed 106 is a frame in which the bed 106 is stored, having beams with a strength capable of supporting the chamber portion disposed thereabove, and on the outer side thereof are arranged plates for covering the bed 106. Examples of utilities include a power supply for supplying power to sensors and the like, a signal interface for receiving signals input to and output from the respective processing units and controlling the same, and control units for controlling these operations.

A lock chamber 113 is arranged at the rear side of the atmospheric block 101 between the transfer chamber 112 of the vacuum block 102, and a space is formed either in the bed 106 or between beds. The rear side of the atmospheric block 101 is a supply passage for supplying gas, refrigerants, power and the like to the vacuum block 102.

The site in which the vacuum processing apparatus 100 is installed is typically a clean room or other rooms in which the air is purified. When multiple apparatuses are installed, the various gases, refrigerants and power supplies to be fed to the vacuum processing chamber 100 are collectively disposed at a different place from where the apparatuses are installed, such as a lower floor from where the apparatuses are installed, and the supply is provided via conduit lines attached to the bodies of the apparatuses. According to the present embodiment, a connection interface 201 of the supply lines of utilities such as pipes of gases and refrigerants or power lines from power supplies from other locations to the main body of the vacuum processing chamber 100 on the floor is disposed in the space on the floor between the rear side of the atmospheric block and the processing unit 103c.

The connection interface 201 functions as a distributor in which supply lines from utilities disposed in other locations are connected to one side while lines of these utilities extending to processing units 103a, 103b, 103c and 104 and the transfer chamber 112 are connected to the other side. The distributor or connection interfaced 201 is equipped with a controller for controlling the supply together with a display device for displaying the amount and rate of supply of the utilities, thereby facilitating the maintenance, inspection and control operations of these utilities by the user in a wide space on the rear side of the atmospheric block 101 where the operation can be performed with ease.

The vacuum processing apparatus 100 of the present embodiment is installed on a floor of a building of the user, using as reference position the position on the lower left end on the front side of the housing 108 in the lower side of the drawing projected on the floor on which the vacuum processing apparatus 100 is to be placed. Further, a line A passing the reference position on a plane perpendicular to the floor surface in the front-rear direction and crossing the floor surface corresponds to the left end of the processing unit 104 seen from the front side. The left end of the processing unit 104 is the left end of the whole body of the vacuum processing apparatus 100, and this left end position is positioned on line A passing the reference position of the installation position of the body of the vacuum processing apparatus 100 in the front-rear direction, wherein the line A is a line indicating the left end of the area in which the vacuum processing apparatus 100 is installed on the floor.

As described, according to the present invention, the left end side wall of the housing 108 corresponds to the left end of the processing unit 104 which is at the left end of the vacuum processing apparatus 100. However, if the distance in the left-right direction (horizontal direction) between the reference position and the left end of the processing unit 104 (left end of the vacuum processing apparatus 100) is known, it is possible to place the left end of the housing 108 (reference position) toward the right side than the left end of the processing unit 104 (left end of the vacuum processing apparatus 100). This arrangement enables to cut down the footprint of the installed vacuum processing apparatus 100.

Further according to the present embodiment, three cassette tables 109 are placed on the front side of the housing 108 facing the transfer passage of the cassettes, in parallel to the direction of transfer of the cassettes. Usually, a cassette housing at least one lot including multiple product wafers to be processed for manufacturing semiconductor devices and other products is placed on each of the cassette tables 109.

Line B, which is a projected line on the floor surface of a plane parallel and perpendicular to the front-rear axis of the vacuum processing apparatus 100 and passing the perpendicular side surface on the right end of the housing 108, passes the floor surface covered by the processing unit 103c connected to the right end side of the transfer chamber 112, and then passes the floor surface occupied by the processing unit 103b placed on the rear side thereof. In other words, the position of line B overlaps with the area on the floor on which the processing units 103b and 103c are placed. Further, a perpendicular plane passing the right end of the connected processing unit 103c (according to the present embodiment, the left end of the vacuum reactor of the processing unit 103c corresponds to the left end of the bed 106c disposed therebelow) and parallel to the above-described front-rear axis is positioned on the right side of the housing 108. The line in which this plane crosses the floor defines the right end of the area of the footprint of the vacuum processing apparatus 100.

The vacuum processing apparatus 100 of the present embodiment is arranged adjacent to another processing apparatus in parallel with the transfer passage of the cassettes on which the cassettes are transferred on the front side of the housing 108. The adjacent processing apparatus is similarly arranged in parallel with the transfer passage disposed on the front side thereof, and normally, the apparatus is disposed so that the front side of the casing of the housings 108 is disposed on the same line parallel to the transfer passage.

The adjacent apparatus also has a line A′ on the left end thereof, and a space is formed on the floor between the left end of the vacuum processing apparatus 100 of FIG. 1 and the adjacent apparatus so as to enable the user to pass therethrough for maintenance and inspection of the two adjacent apparatuses. Similarly, a space on the rear side of the depth end of the vacuum processing apparatus 100 on the upper side in the drawing of the processing units 103a and 103b is used as a space for maintenance and inspection. In other words, the floor space shown by the area between the one-dot dashed line and the two-dot dashed line and the space above that area is formed between adjacent apparatuses when installing the vacuum processing apparatus 100, which is used as allowance space to be used by the user during operation of the vacuum processing apparatus 100. This space can be used, for example, by a user passing with a carrier such as a wagon with wheels carrying maintenance appliances, or for operation in which the operator operates the processing units 103a, 103b, 103c and 104.

According to the present embodiment, at least one of the processing units 103a, 103b, 103c and 104 are attached to the transfer chamber 112 in a removable manner while other units are connected to the transfer chamber 112 and in operation. Such processing units 103b and 103c may be detached from the main body for replacement after being installed on the floor with the main body of the vacuum processing apparatus 100, or can be connected and attached to the main body after the main body is installed on the floor surface without some of the processing units. In such case, if the MFC units or the atmospheric block 101 must be moved or if the main body of the vacuum processing apparatus 100 must be moved, the installation operation of units will take up a long time, and the efficiency of the processes performed by the apparatus is deteriorated.

Thus, the vacuum processing apparatus 100 must be installed so that the space surrounding the vacuum processing apparatus 100 can be used to facilitate easy attachment and removal of the processing units 103a through 103c or maintenance and inspection operations. On the other hand, in view of improving the efficiency of the manufacture of semiconductor devices manufactured by the user, it is required that the futile space of the footprint of the vacuum processing apparatus 100 is reduced and the area thereof is minimized.

According to the present invention, the position of the housing 108 is arranged while taking into consideration the above viewpoints, so that the futile space of the footprint of the apparatus on the floor on which the vacuum processing apparatus 100 is installed is cut down. As described, the apparatuses are usually installed adjacent to one another along the passage for transferring cassettes, and if the interval between the apparatuses are reduced, the number of apparatus capable of being installed within a room, such as a clean room, is increased, by which the manufacturing efficiency is improved and the manufacturing costs are reduced. The area required for installing the apparatus is considered to be the width along the transfer passage in the lateral direction and the depth direction perpendicular to the passage, wherein according to the present embodiment illustrated in FIG. 1, the futile space required for installation is sufficiently reduced. Further, the processes that must be performed by the apparatus depends on the user, and thus the number of units to be assembled differs, so that if only three or two units are assembled, the width of the device is determined by the distance between the left end of the apparatus and the portion corresponding to the processing units 103c and 103b positioned at the right end of the apparatus. Therefore, the width of the apparatus is reduced if the number of processing units to be used is reduced.

Further, as shown in FIG. 2, a roof 202 for opening and closing the vacuum reactor is arranged on the upper portion of the vacuum transfer reactor 110 of the transfer chamber 112, which is capable of being rotated around a hinge arranged near the rear surface of the housing 108. This rotating movement is realized by a hoisting device not shown, revolving around a hinge disposed near the connecting portion between the lock chambers 113 and 113′ and the housing 108 and positioned above and between the lock chambers 113 and 113′. A seal for airtightly sealing the interior of the transfer chamber 112 by coming into contact with the main body of the vacuum transfer reactor 110 is arranged on the inner surface (lower side in the drawing) of the roof 202, having a shape corresponding to the polygonal roof 202. In the present drawing, the processing unit 103c is not shown in the drawing for easier description of the above arrangement.

Moreover, the processing units 103a through 103c support chamber units 106a′ through 106c′ mounted on a plurality of post-shaped supporting members 205 arranged on a flat surface above the beds 106a through 106c. In the spaces between the chamber units 106a′ through 106c′ and beds 106a through 106c, vacuum devices 204a through 204c including vacuum pumps such as turbomolecular pumps for evacuating and depressurizing the interior of the processing chambers are respectively arranged and connected to a bottom surface of the vacuum reactors of chamber units 106a′ through 106c′.

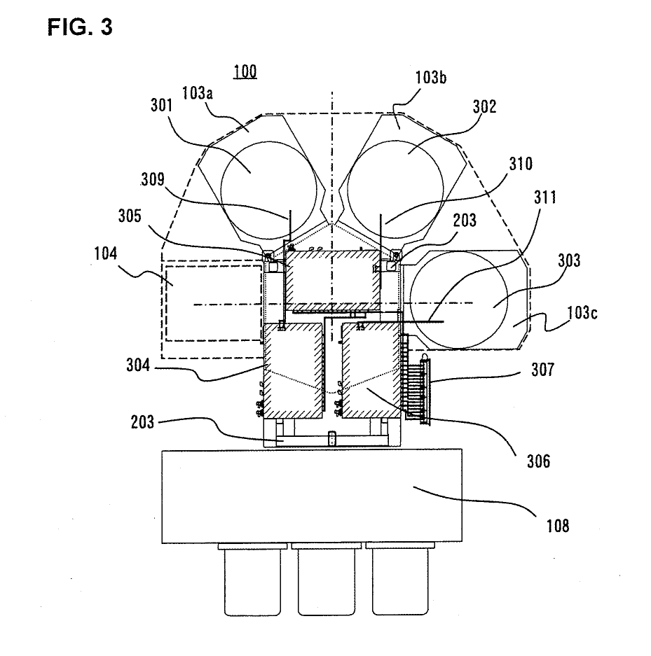

The upper plane of each bed 106a through 106c is composed of a planar plate member. Workers can step on the plate members constituting the upper plane of the beds 106a through 106c for operating the processing units 103a through 103c and the vacuum transfer reactor 110. Therefore, the beds 106a through 106c constitute a structure capable of supporting the weight of the workers. Moreover, as shown by the broken line of FIG. 3, there are spaces formed between the beds of the processing units in which the workers can enter and perform operation. Therefore, the upper surfaces of the beds 106a through 106c are set to the same height, and a removable platform having a panel member with the same upper plane height is disposed between the beds so as to connect the space formed between beds 106a through 106c. The same structure is adopted for the processing unit 104.

In other words, according to the present embodiment, the circumference of the vacuum transfer reactor 110 is surrounded by a plate-shaped member having an equal upper plane height disposed below the processing units 103a, 103b, 103c and 104 arranged around the vacuum transfer reactor 110. The plane having the same height is used as the platform on which the workers can perform operation.

The lower portion of the interior of the housing 108 defines a space communicated with the interior of a cassette mounted on the cassette table 109 arranged on the front side of the housing, forming an atmospheric transfer chamber in which the atmospheric transfer robot 207 arranged therein for transferring wafers under atmospheric pressure is driven along the array of cassette tables 109. On the other hand, the upper portion of the interior of the housing 108 defines a space in which a control unit 208 for controlling the operation of the transfer unit 105 including the atmospheric transfer robot 207, the vacuum transfer robot disposed within the vacuum transfer reactor 110 and the transfer chamber 112 within the vacuum transfer reactor 110. Further, below the vacuum transfer reactor 110 is arranged a frame 203 which is a structural body having beams assembled in the shape of a box for supporting the vacuum transfer reactor on the floor surface, wherein the frame 203 is connected to and attaches the floor surface and the lower surface of the vacuum transfer reactor 110. As described in detail later, the space formed between the floor surface and the vacuum transfer reactor 110 in the interior of the frame 203 is a space for installing equipments used for operating the vacuum processing apparatus 100, and includes a space 206 used for performing maintenance and inspection operations.

FIG. 3 is a plan view showing the arrangement of a MFC unit and the processing unit disposed below the transfer chamber according to the embodiment shown in FIG. 1. Three mass flow controller (MFC) units 304, 305 and 306 which are control units for controlling the flow rate of the supply of processing gas supplied to etching chambers 301, 302 and 303 arranged respectively in each of the processing units 103a, 103b and 103c are disposed in the space below the transfer chamber 112 constituting the transfer unit 105 or lock chambers 113 and 113′. The etching chambers 301, 302 and 303 and the MFC units 304, 305 and 306 are arranged clockwise around the buffer chamber. The MFC units 304 and 306 are arranged in parallel at the lower area in the drawing, and the MFC unit 305 is arranged orthogonally at the upper side in the drawing.

The MFC units 304, 305 and 306 of the present embodiment are rectangular box-shaped members, in which pipes or lines for supplying sixteen gases are arranged in parallel therein. Each line through which gas travels is equipped with a flow rate controller for controlling the valves for closing and opening the flow paths and the flow rates per unit time and controllers for controlling these operations based on demands from the control unit arranged within the main body of the vacuum processing apparatus 100. Each MFC unit 304, 305 or 306 has sixteen gas supply pipes connected to the side walls of the box-shaped body, and processing chamber gas supply pipes 309, 310 and 311 in which the lines in the interior of the MFC units are converged are connected to another side wall of the box-shaped body and extended to the processing units 103a, 103b and 103c to be respectively connected thereto.

The MFC units 304, 305 and 306 are respectively arranged below the transfer chamber 112 in parallel to the floor at positions corresponding to the positions in which the corresponding etching chambers 301, 302 and 303 to which each MFC unit supplies gases is arranged around the vacuum transfer reactor 110. Therefore, the processing units 103a, 103b and 103c and etching chambers 301, 302 and 303 enclosed therein are arranged radially clockwise around the center of the vacuum transfer reactor 110 (the center of rotation of the vacuum transfer robot) shown by the cross point of dotted lines so that the center positions of the sample stages disposed in the chambers are at equal distances from the center. On the other hand, the MFC units 304, 305 and 306 are also radially disposed around the same axis below the transfer unit 105, and their positions or order in the clockwise direction correspond to the order of the processing units 103a, 10b and 103c or the etching chambers 301, 302 and 303.

Further, the MFC units 304, 305 and 306 are arranged so that the lengths of the processing chamber gas supply pipes 309, 310 and 311 connected thereto are substantially equal. By reducing the difference in lengths of the supply paths of processing gases to the etching chambers 301, 302 and 303, it becomes possible to reduce the difference in performance of the processes performed in the etching chambers 301, 302 and 303, so as to suppress so-called device variations. Further, since the MFC units 304, 305 and 306 are arranged near the respective etching chambers 301, 302 and 303, the gas flow rate control performed by the MFC units 304, 305 and 306 is reflected in a very short time to the flow rate within the etching chambers 301, 302 and 303, by which the response of the processes is improved, and thus, the throughput is improved.

Further, the MFC units 304, 305 and 306 are arranged so that the planes facing the vertical axis passing the center of the vacuum transfer reactor 110 of the box-shaped beds 106a, 106b, 106c and 107 having rectangular shapes or substantially rectangular shapes formed of curved and flat planes arranged in the circumference of the vacuum transfer reactor 110 or the frame 201 disposed therebelow are not covered by the MFC units 301, 302 and 303. On the side walls of the beds 106a, 106b, 106c and 107 facing the center are arranged connecting interfaces for connecting pipes and cables communicating the inner utilities with the utilities arranged in the space below the vacuum transfer reactor 110, so that in order to attach or remove any of the processing units 103a, 103b, 103c or 104, operators must work on this connecting interface. Therefore, the MFC units are not arranged on this side, so as not to reduce the space in which the worker can work on the connecting interfaces, and deteriorate the work efficiency. According to the present embodiment, the lines such as pipes and cables connected to the connecting interfaces are arranged to pass through the outer circumference of the area in which the MFC units 304, 305 and 306 are arranged, so as to facilitate operations such as arranging, attaching and removing operations.

A gas distributor 307 for distributing and supplying sixteen lines of gases to each of the MFC units 304, 305 and 306 is arranged on the floor on the right side of the vacuum transfer reactor 110 in the drawing between the housing 108 and the processing unit 103c. The gas distributor 307 receives supply of sixteen gases supplied to the floor on which the vacuum processing apparatus 100 is installed through paths such as pipes connected from a floor below the floor on which the vacuum processing apparatus 100 is installed, wherein the gases are diverged and supplied to each of the MFC units 304, 305 and 306.

The gas distributor 307 has pipes of sixteen gases supplied from the floor below connected to the gas pipes communicated with the respective MFC units 304, 305 and 306, and has valves for closing and opening the flow of gases disposed in each of the paths. The pipes of the sixteen gases from the gas distributor 307 are disposed in the space formed between the side walls facing each other of the respective MFC units 304, 305 and 306, which are diverged and connected to each of the MFC units.

The gas distributor 307 is disposed on the floor surface between the front side wall of the processing unit 103c and the rear surface of the housing 108, and the upper surface thereof is covered by a removable platform with a planar plate member not shown arranged at the same height as the bed 106c. This plate member covers the space above the floor between the front side surface of the processing unit 103c and the rear surface of the housing 108 and supports the weight of the worker working on the plate member, so that the space can be used for operation on which a worker can stand on. Especially, the space below the vacuum transfer reactor 110 not only has MFC units 304, 305 and 306 arranged therein but also provides a work space enabling maintenance and inspection operations to be performed with respect to the processing units 103a, 103b, 103c and 104, especially the beds 106a, 106b, 106c and 107. The above-described plate member on the floor forms a passage on the upper surface thereof on which a worker can easily move within the work space.

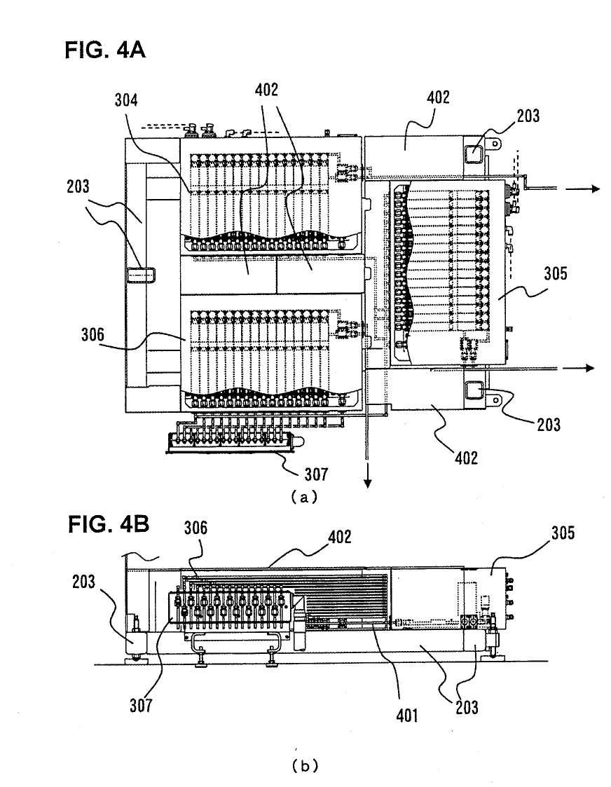

FIG. 4 is a view showing the detailed arrangement of the MFC unit illustrated in FIG. 3. FIG. 4A is an upper view, and FIG. 4B is a side view thereof. In FIG. 4, the MFC units 304, 305 and 306 having a rectangular box-like shape is mounted on and arranged adjacent to one another on the frame 201. Sixteen gas supply pipes 401 extended from the gas distributor 307 to the MFC units 304 and 305 are arranged in parallel in the space between the side walls of these box-shaped members.

The MFC units 304, 305 and 306 have respective flow controllers for each line of gas, and the gas lines are arranged horizontally in parallel in the housing of the box-shaped body. Sixteen lines are converged as a single line within the space of the box-shaped body on the lower stream side from the flow controllers, and the outlet port of each line is connected to and converged in a flow out pipe connected to the side walls of the respective box-shaped body. The gas flowing from each line is converged to at least one supply line and supplied via a connecting portion on the side wall of the housing to processing chamber gas supply pipes 309, 310 and 311 connected thereto to be supplied to the respective etching chambers 301, 302 and 303.

Further, a flat plate member 402 is disposed above the space formed between the MFC units 304, 305 and 306, and the height of the upper plane thereof is formed so as to correspond to the upper plane of the MFC units 304, 305 and 306. Similarly, plate members 402 are disposed in the space above and below the MFC unit in the drawing (that is, the left and right sides in the vacuum processing apparatus of FIG. 1). The MFC units 304, 305 and 306 according to the present embodiment are substantially of same structure and same shape, so that when the spaces between the units are connected by plate members having the same height as the upper plane of the units, a planar area including the upper surfaces of the MFC units 304, 305 and 306 is formed below the transfer chamber 112.

Further according to the present embodiment, the height of the MFC units 304, 305 and 306 and the plate member 402 is equal to the planar upper surfaces of the beds 106a, 106b, 106c and 107 disposed below the processing units 103a, 103b, 103c and 104 and with the upper surface of the plate members of the platform disposed between the beds. In other words, a planar area having the same height is formed at the lower portion of the vacuum block 102 disposed rearward from the housing 108 of the vacuum processing apparatus 100, enabling works to perform operation in the area safely and with ease. Further, space 206 which is the space below the lower surface of the vacuum transfer reactor 110 and above the MFC units 304, 305 and 306 ensures sufficient height so as to allow workers to enter and perform operation therein, and the members constituting the flat plane has sufficient strength to support the worker. This space and the flat lower surface having the same height allows necessary operation to be performed with ease, by which the maintenance and inspection operation time, and therefore, the nonoperating time of the vacuum processing apparatus 100, can be reduced.

Furthermore, the box-shaped bodies of the MFC units 304, 305 and 306 according to the present embodiment are designed so that their upper planes are removable in the upper direction. Therefore, the worker entering the space below the vacuum transfer reactor 110 can remove the upper plane of the box-shaped body of the arbitrary MFC unit so as to work with or inspect the lines of the respective gases arranged in parallel in the horizontal direction in the units, by which the operation time is reduced and the efficiency is improved.

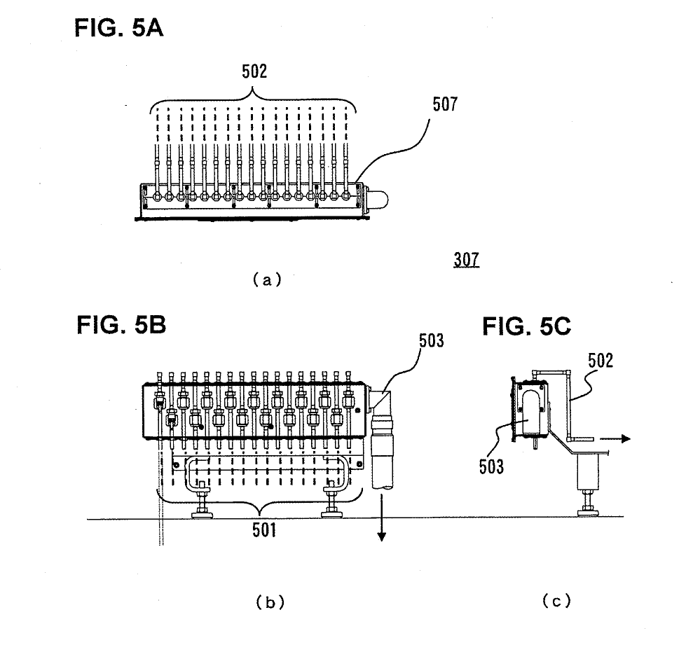

FIGS. 5A, 5B and 5C are three side views showing in detail the arrangement of the gas distributor 307 of FIG. 4. The gas distributor 307 comprises a fitting box 507 as a main body in which supply pipes for sixteen gases are arranged in parallel in a row. Gas supply pipes 501 extending from a floor below and extended upward from the floor surface are connected to gas supply pipes 502 extended above the box and connected to each of the MFC units 304, 305 and 306 within this box. Gas supply pipes 702 extended from within the box are arranged in a row on the upper plane of the gas distributor 307, and the pipes are each diverged respectively toward the MFC units 304, 305 and 306.

Further, a gas evacuation pipe 503 extending below the floor surface is formed to the fitting box 507 of the gas distributor 307 to enable the gas inside the gas distributor to be evacuated, thereby preventing the gas leaked within the box from being released in the building in which the vacuum processing apparatus 100 is installed, such as a clean room.

The above-described embodiment enables to cut down the operations for removing components during maintenance and inspection or for aligning the attached components, and to reduce the non-operating time (time while the apparatus is not operated) of the apparatus. Thereby, the efficiency of the processes is improved. Further, the present embodiment enables to overcome the drawbacks of the footprint being enlarged and reducing maintenance space and work space, and thereby, enables to improve the efficiency of the processes.

Moreover, the present embodiment enables to improve the response performance when changing processing conditions such as the processing gases for processing a sample continuously, and to thereby improve the throughput and enhance the efficiency of the processes.

What is claimed is:

1. A vacuum processing apparatus for processing a sample placed within a processing chamber in a vacuum reactor using plasma generated within the processing chamber, the apparatus comprising:
an atmospheric transfer chamber disposed on a front portion of the apparatus for transferring the sample under atmospheric pressure;
a vacuum transfer chamber arranged on a rear side of the atmospheric transfer chamber for transferring the sample in the inner side of the chamber being vacuumed;
a lock chamber disposed between and connecting the vacuum transfer chamber and the atmospheric transfer chamber;
a plurality of vacuum processing units including vacuum reactors and arranged in the circumference of and connected to the vacuum transfer chamber; and
a plurality of flow controllers arranged in a space below the vacuum transfer chamber or the lock chamber for controlling flow rates of a plurality of gases to be supplied respectively to the vacuum processing units for processing the sample.

2. The vacuum processing apparatus according to claim 1, wherein
the vacuum transfer chamber is disposed in a reactor having a polygonal planar shape and having vacuum processing units attached in a removable manner to side walls constituting the polygonal sides of the reactor.

3. The vacuum processing apparatus according to claim 1 or claim 2, further comprising a gas distributor disposed between the atmospheric transfer chamber and the vacuum processing unit arranged on the rear side of the atmospheric transfer chamber, and connected to a plurality of pipes for gases supplied from below a floor surface on which the vacuum processing apparatus is installed for distributing the plurality of gases to the plurality of flow controllers, respectively.

4. The vacuum processing apparatus according to any one of claims 1 or 2, wherein the center portions of the processing chambers within the plurality of vacuum processing units are arranged circumferentially around a vertical center axis of the vacuum transfer chamber, and the plurality of flow controllers are arranged below the vacuum transfer chamber circumferentially around the vertical axis and in an order corresponding to the circumferential position of the corresponding vacuum processing units.

5. The vacuum processing apparatus according to claim 3, wherein the center portions of the processing chambers within the plurality of vacuum processing units are arranged circumferentially around a vertical center axis of the vacuum transfer chamber, and the plurality of flow controllers are arranged below the vacuum transfer chamber circumferentially around the vertical axis and in an order corresponding to the circumferential position of the corresponding vacuum processing units.

6. The vacuum processing apparatus according to any one of claims 1 or 2, wherein upper surfaces of the plurality of flow controllers are composed of planes of the same height, and a space in which a worker can perform operation is provided between the vacuum transfer chamber and the plurality of flow controllers.

7. The vacuum processing apparatus according to claim 3, wherein upper surfaces of the plurality of flow controllers are composed of planes of the same height, and a space in which a worker can perform operation is provided between the vacuum transfer chamber and the plurality of flow controllers.

8. The vacuum processing apparatus according to claim 4, wherein upper surfaces of the plurality of flow controllers are composed of planes of the same height, and a space in which a worker can perform operation is provided between the vacuum transfer chamber and the plurality of flow controllers.
